(19) United States
(12) Patent Application Publication
(10) Pub. No.: US 2026/0140813 A1
(43) Pub. Date: May 21, 2026

(54) MONITORING REPEATING COMPUTERIZED PROCESSES

(71) Applicant: SAP SE, Walldorf (DE)

(72) Inventors: Shashank Mohan Jain, Karnataka (IN); Kavitha Krishnan, Bangalore (IN)

(21) Appl. No.: 18/954,157

(22) Filed: Nov. 20, 2024

(51) Int. Cl. G06F 11/07; G06N 3/0455

(52) U.S. Cl. CPC G06F 11/0793; G06F 11/0721; G06N 3/0455

(57) ABSTRACT

Various examples are directed to systems and methods of managing a repeating computerized process comprising a first operation and a second operation. A process monitoring system may generate a first metric vector describing execution of the repeating computerized process during a first time period. The first metric vector may be based at least in part on a first metric value describing execution of the first operation during the first time period and a second metric value describing execution of the second operation during the first time period. The process monitoring system may execute a trained computerized autoencoder model using the first metric vector to generate a first modeled metric vector and detect an anomaly in the execution of the repeating computerized process during the first time period based at least in part on an output of the trained computerized autoencoder model.

### BACKGROUND

Many computing solutions utilize repeating computerized processes. Repeating computerized processes may involve operations that are performed at different computing devices and sometimes involving the input of multiple different human users.

It may be desirable for an enterprise implementing a repeating computerized process to understand the performance of the process including, for example, problems that may be related to the design of the process, the computing devices executing the process, human users involved in the process, and/or the like. Consider an example of a computerized process for procuring materials in an enterprise. Such a computerized process may include operations such as, for example, receiving a procurement request from a requesting user via a procurement user interface, soliciting approval of the procurement from a purchasing manager, generating a purchase order, and/or the like. Different operations may be performed by different computing devices and based on input from different users.

One challenge associated with managing repeating computerized processes is the distributed nature of the repeating computerized processes. For example, because the process involves multiple computing devices and may involve multiple human users, there may not be a single computing device or human user that is exposed to the entirety of the repeating computerized process. Also, even if data describing the repeating computerized process is gathered from the multiple executing computing devices, it may be challenging to use the data to determine efficiency, security, and other performance-related issues across multiple devices. For example, the execution of that operation and one computing device may affect the overall efficiency of the repeating computerized process in a manner that is not individually apparent at any one computing device.

### BRIEF DESCRIPTION OF DRAWINGS

The present disclosure is illustrated by way of example and not limitation in the following appendices and figures.

FIG. 1 is a diagram showing one example of an environment comprising a process monitoring system configured to manage a repeating computerized process.

FIG. 2 is a workflow showing one example of a repeating computerized process for initiating a purchase requisition in a business organization.

FIG. 3 is a flowchart showing one example of a process flow that may be executed in the environment of FIG. 1 to manage a repeating computerized process.

FIG. 4 is a flowchart showing one example of a process flow that may be executed in the environment of FIG. 1 to generate a metric vector describing the operation of a repeating computerized process over a time period.

FIG. 5 is a flowchart showing one example of a process flow that may be executed in the environment of FIG. 1 to train the computerized autoencoder model.

FIG. 6 is a flowchart showing one example of a process flow that may be executed in the environment of FIG. 1 to determine an operation or operations that are correlated to a detected anomaly at a repeating computerized process.

FIG. 7 is a block diagram showing one example of an architecture for a computing device.

FIG. 8 is a block diagram of a machine in the example form of a computing system within which instructions may be executed to cause the machine to perform any one or more of the methodologies discussed herein.

### DETAILED DESCRIPTION

Various examples address the challenges of managing repeating computerized processes, and other challenges, by utilizing systems and methods for managing repeating computerized process that utilizes a trained autoencoder model. A process monitoring system may collect data from multiple computing devices executing different operations of a repeating computerized process. The process monitoring system may generate a metric vector describing the execution of the computerized process during a time period. The metric vector may include metric values describing the execution of different operations of the repeating computerized process during the time period. In some examples, the metric values are based on multiple executions of the repeating computerized process that occurred during the time period. For example, the example computerized procurement process introduced herein may be executed multiple times during the time period.

The trained autoencoder model may comprise an encoder configured to transform the metric vector into a latent space vector and an encoder that is configured to transform the latent space vector into a modeled metric vector. The trained autoencoder model may be trained with training data describing correct or non-anomalous executions of the repeating computerized process. Accordingly, when a metric vector describing a correct or nonanomalous execution of the repeating computerized process is provided as input to the trained autoencoder model, the modeled metric vector may match the metric vector. The process monitoring system may compare the modeled metric vector to the metric vector. Differences between the modeled metric vector and the metric vector may indicate that the execution of the repeating computerized process was incorrect or anomalous during the time period.

In some examples, the process monitoring system is configured to determine one or more operations of the repeating computerized process that are anomalous. For example, the process monitoring system may determine a partial difference between the metric vector and the modeled metric vector with respect to particular operations of the repeating computerized process. In some examples, the operation having the largest difference may be the operation most likely to have been the source of the anomaly.

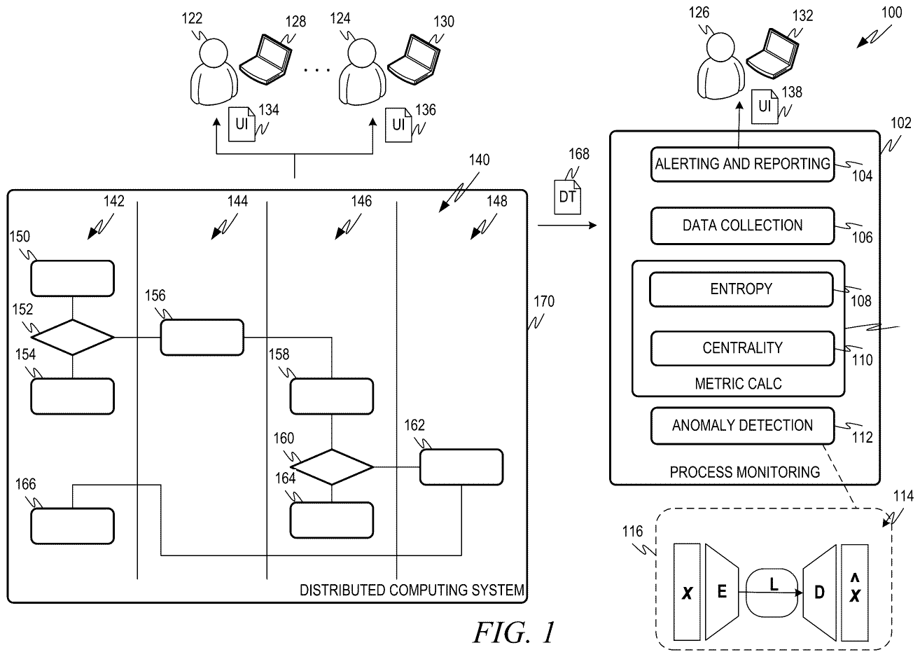

FIG. 1 is a diagram showing one example of an environment 100 comprising a process monitoring system 102 configured to manage a repeating computerized process 140. The repeating computerized process 140 is executed at a distributed computing system 170. The distributed computing system 170 may comprise multiple constituent computing systems 142, 144, 146, 148. The computing systems 142, 144, 146, 148 may each comprise one or more computing devices. The distributed computing system 170 may be located at a common geographic location and/or distributed across multiple different geographic locations. Similarly, the individual computing systems 142, 144, 146, 148 may be located at a common geographic location and/or distributed across multiple different geographic locations. The repeating computerized process 140 may be repeating. For example, the repeating computerized process 140 may be executed repeatedly, for example, by different users 122, 124, and/or at different times.

The example repeating computerized process 140 comprises operations 150, 152, 154, 166 that are executed at the computing system 142. Operation 156 is executed at the computing system 144. Operations 158, 160, and 164 are executed at the computing system 146. The operation 162 is executed at the computing system 148. The distributed computing system 170 may execute the computerized process 140 at least in part in conjunction with one or more users 122, 124. Various systems 142, 144, 146, 148 of the distributed computing system 170 may provide one or more user interfaces 134, 136 to users 122, 124 via user computing devices 128, 130. The user computing devices 128, 130 may be or include any suitable computing device such as, for example, a mobile computing device, a laptop computing device, a desktop computing device, and/or the like. It will be appreciated that the configuration of the repeating computerized process 140 shown in FIG. 1 is just one example of a repeating computerized process that may be managed as described herein. For example, repeating computerized processes managed as described herein may comprise different combinations of operations, more or fewer operations, a different distribution of operations between computing systems, a different number of computing systems, and/or the like.

The process monitoring system 102 may comprise various subsystems, including a data collection system 106, a metric calculation system 118, an anomaly detection system 112, and an alerting and reporting system 104. The data collection system 106 collects data 168 describing the computerized process 140. The data 168 may describe how the repeating computerized process 140 is executed over time. For example, the data 168 may indicate descriptions of how the respective operations 150, 152, 154, 156, 158, 160, 162, 164, 166 are executed. This may include, for example, the number of times that each operation 150, 152, 154, 156, 158, 160, 162, 164, 166 is executed, the time taken to execute the operations 150, 152, 154, 156, 158, 160, 162, 164, 166 each time that the respective operations are executed, transitions between operations 150, 152, 154, 156, 158, 160, 162, 164, 166, a number and/or type of messages sent during execution of the operations 150, 152, 154, 156, 158, 160, 162, 164, 166, a number and/or type of messages received during execution of the operations 150, 152, 154, 156, 158, 160, 162, 164, 166, and/or the like.

The metric calculation system 118 may generate one or more metrics describing the repeating computerized process 140. In some examples, an entropy system 108 may determine an entropy associated with the various operations 150, 152, 154, 156, 158, 160, 162, 164, 166. The entropy associated with an operation may describe a level of uncertainty or randomness associated with the operation. For example, the entropy associated with an operation may indicate a degree of randomness associated with whether the operation executes, whether the operation is triggered by another particular operation, whether the operation leads to another particular operation, and/or the like.

In some examples, the entropy system 108 determines entropies associated with various metrics describing an operation 150, 152, 154, 156, 158, 160, 162, 164, 166. For example, the entropy system 108 may determine an entropy associated with whether the operation executes during an instance of the repeating computerized process 140, an entropy associated with whether the operation is triggered by another particular operation, an entropy associated with whether the operation triggers another particular operation, an entropy associated with the execution time of an operation, an entropy associated with the number of messages sent by the operation, an entropy associated with the number of messages received by the operation, and/or the like. In some examples, entropy for an operation 150, 152, 154, 156, 158, 160, 162, 164, 166, and/or a metric describing an operation is determined using the Shannon entropy formula. Other suitable measures of entropy may also be used.

A centrality system 110 may determine a centrality measure for each of the operations 150, 152, 154, 156, 158, 160, 162, 164, 166. The centrality of an operation may describe the importance or significance of the operation 150, 152, 154, 156, 158, 160, 162, 164, 166 in view of the repeating computerized process 140 as a whole. In some examples, the centrality is an eigenvector centrality. The centrality system 110 may generate a transition matrix describing transitions between the operations 150, 152, 154, 156, 158, 160, 162, 164, 166 of the repeating computerized process 140. The transition matrix may have a number of rows and columns where each row and each column correspond to one of the operations 150, 152, 154, 156, 158, 160, 162, 164, 166. The values of the matrix may correspond to the number of transitions from the operation indicated by the row to the operation indicated by the column or the number of transitions from the operation indicated by the column to the operation indicated by the row. The eigenvector centrality of the respective operations 150, 152, 154, 156, 158, 160, 162, 164, 166 is determined from the transition matrix.

The anomaly detection system 112 may use metrics determined by the metric calculation system 118 to detect anomalies in the execution of the repeating computerized process 140. For example, the anomaly detection system 112 may execute a trained computerized autoencoder model 114. To utilize the trained computerized autoencoder model 114, the anomaly detection system 112 may generate, for each of the operations 150, 152, 154, 156, 158, 160, 162, 164, 166, a matrix vector. The matrix vector describing an operation may comprise values for one or more metrics describing the operation over a particular time. This may include, for example, a centrality of the operation, an entropy of the operation, and, in some examples, one or more additional entropies describing specific properties of the operations such as, for example, an entropy of the operation's execution time during the time period, and entropy of the number of messages sent and/or received by the operation during the time period, and/or the like.

In the example of FIG. 1, a representation of the trained computerized autoencoder model 114 is shown in breakout window 116. The metric vector, represented by X, is provided as input to an encoder model, represented by E. The encoder model converts the metric vector to a latent space vector, represented by L. The latent space vector is provided to a decoder model, represented by D. The decoder model converts the latent space vector to a modeled metric vector, represented by \hat{X}.

In some examples, the trained computerized autoencoder model 114 is arranged with a memory so that the output of the model (e.g., the modeled metric vector) is based on the most recent metric vector as well as previous metric factors. For example, the trained computerized autoencoder model 114 may be arranged with an encoder and a decoder that include and/or are based on a Long Short Term Memory (LSTM) Recurrent Neural Network (RNN).

The trained autoencoder model 114 may be trained using training data that is derived from correct or non-anomalous executions of the repeating computerized process 140. For example, the trained autoencoder model 114 may be trained to generate the modeled metric vector to closely match the input metric vector for executions of the repeating computerized process 140 that are correct or nonanomalous. Accordingly, after training, the anomaly detection system 112 may determine whether the repeating computerized process 140 is executing in an anomalous manner during the considered time period by comparing the modeled metric vector generated by the trained autoencoder model 114 to the actual metric vector describing the repeating computerized process 140 during the time period. If the metric vector is equal to or similar to the modeled metric vector, it may indicate that the repeating computerized process 140 was executed in a nonanomalous manner during the considered time period. If the modeled metric vector generated by the trained autoencoder model 114 differs from the input metric vector by more than a threshold, the anomaly detection system 112 may determine that execution of the repeating computerized process 140 during the considered time period is anomalous.

The anomaly detection system 112 may determine the distance between a metric vector describing execution of the repeating computerized process 140 during a time period and the corresponding modeled metric vector determined by the trained computerized autoencoder model 114 in any suitable manner. In some examples, the anomaly detection system 112 may utilize a vector difference between the two factors, such as, for example, a mean square error, an absolute error, and/or the like.

In some examples, the anomaly detection system 112 may also determine one or more operations 150, 152, 154, 156, 158, 160, 162, 164, 166 of the repeating computerized process 140 that contributed to a detected anomaly. Recall that the metric vector comprises components corresponding to the individual operations 150, 152, 154, 156, 158, 160, 162, 164, 166 of the repeating computerized process 140, such as, for example, a centrality of the operation, an entropy of the operation, one or more entropy is of other properties of the operation, and/or the like. The anomaly detection system 112 may identify the contribution of individual operations 150, 152, 154, 156, 158, 160, 162, 164, 166 to a detected anomaly, for example, by finding a partial derivative or other partial difference of the metric vector and modeled metric vector. For example, the anomaly detection system 112 may find a partial difference between the metric vector and the modeled vector with respect to the components of the vectors that correspond to the operation 150. A similar partial difference may be found with respect to the operation 152, and so on. The respective partial differences may indicate the contribution of the respective operations 150, 152, 154, 156, 158, 160, 162, 164, 166 to a detected anomaly. For example, operations having a higher partial difference may have a larger contribution to the detected anomaly.

The alerting and reporting system 104 may provide an administrative user interface 138 to a user 126. The user 126 may access the administrative user interface 138 using a user computing device 132, which may be similar to the user computing devices 128, 130. The administrative user interface 138 generated by the alerting and reporting system 104 may comprise indications and/or plots of various metrics generated by the metric calculation system 118.

The alerting and reporting system 104 may also be configured to execute a responsive action when the anomaly detection system 112 determines that execution of the repeating computerized process 140 has been anomalous during a considered time period. The responsive action may include reporting the detected anomaly to one or more administrative users, such as administrative user 126. In some examples, the responsive action may include assigning one or more of the operations 150, 152, 154, 156, 158, 160, 162, 164, 166 to a different user 122, 124. In some examples, the responsive action may include shifting one or more of the operations 150, 152, 154, 156, 158, 160, 162, 164, 166 to a different computing device. This may include, for example, shifting one or more of the operations from one of the computing systems 142, 144, 146, 148 to another. In other examples, this may include shifting one or more of the operations from one server or another hardware resource to a different server or hardware resource.

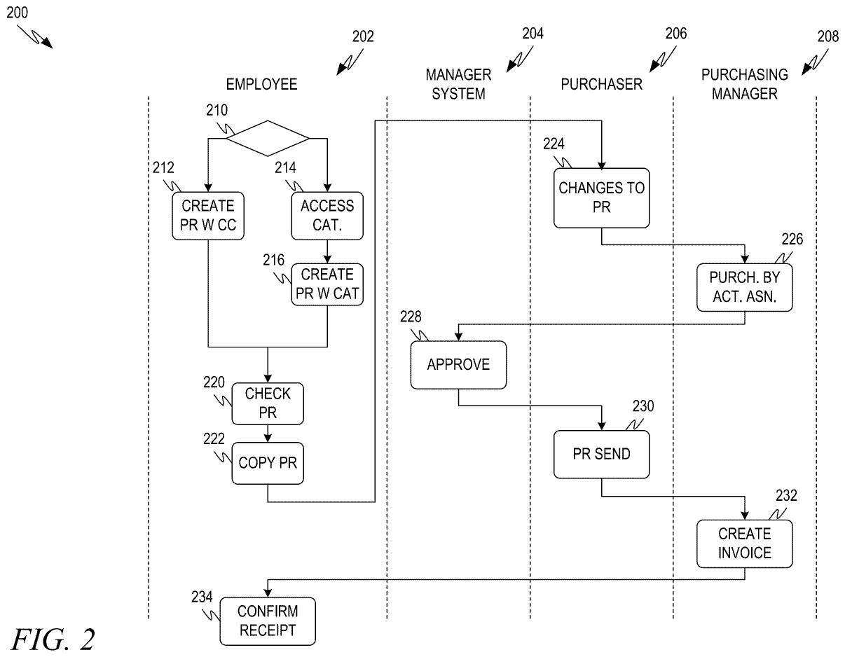

FIG. 2 is a workflow showing one example of a repeating computerized process 200 for initiating a purchase requisition in a business organization. The repeating computerized process 200 is one example of a repeating computerized process that may be managed, for example, as described herein. The repeating computerized process 200 is executed using a distributed computing system that comprises an employee computing system 202, a manager computing system 204, a purchaser computing system 206, and a purchasing manager computing system 208.

One or more of the computing systems 202, 204, 206, 208 may be associated with a corresponding user. For example, the employee computing system 202 may be associated with and/or used by a user, such as, for example, an employee of the enterprise implementing the repeating computerized process 200. The manager computing system 204, in some examples, may be associated with a user who is a manager of the employee. The purchasing manager system 208 may be associated with a user who is a purchasing manager at the enterprise implementing the repeating computerized process 200. In this example, the purchaser computing system 206 is not associated with a user and executes automated operations 224, 230.

In the example repeating computerized process 200, at a first decision operation 210, the employee computing system 202 determines whether to create the purchase requisition with a cost center or from a catalog. This may be determined automatically by the employee computing system 202, for example, based on input from the employee user. In other examples, the employee user may select whether to create the purchase requisition using a cost center or a catalog.

If a cost center is selected at operation 210, then the employee computing system 202 may create a purchase requisition with the cost center at operation 212. This may involve, for example, prompting a server to generate the purchase requisition using the cost center. If catalog is selected at operation 210, the employee computing system 202 may access catalog items at operation 214 and create the purchase requisition using one or more of the accessed catalog items at operation 216.

The employee computing system 202 may check the purchase request at operation 220 and copy the purchase request to the purchaser computing system 206 at operation 222. At operation 224, the purchaser computing system 206 may make changes to the purchase requisition. For example, the purchaser computing system 206 may pull the purchase requisition with other similar purchase requisitions (e.g., from the same supplier). At operation 226, the purchasing manager system 208 may initiate the purchase of the goods and/or services that are the subject of the purchase requisition. For example, the purchasing manager computing system 208 may provide a purchasing manager user with an indication of the purchase requisition, which the purchasing manager user may accept or deny. At operation 228, the manager computing system 204 may approve the purchase requisition. The manager computing system 204, for example, may query a manager user to approve the purchase requisition. In some examples, the manager user is a manager of the employee user at the organization implementing the repeating computerized process 200.

At operation 230, the purchaser computing system may send the purchase requisition to a supplier for fulfillment. At operation 232, the purchasing manager computing system may create an invoice associated with the purchase requisition. At operation 234, may confirm receipt of the requisitioned goods and/or services. For example, the employee user may be prompted to provide an indication that the goods and/or services have been received.

The example of FIG. 2 may be used to illustrate example anomalies. Consider an example in which the changes to purchase requisition operation 224 or purchase requisition send operation 230 are executed multiple times due to hardware-based failures, such as flutter. In this example, the entropy of the operations 224 and 230 may increase. Also, because these operations 224, 230 are being initiated multiple times for each execution of the repeating computerized process 200, the centrality of the operations 224, 230 may also increase. As a result, the anomaly detection system 112 may detect an anomaly in the execution of the repeating computerized process 200 and may identify the operations 224, 230 as being correlated to the anomaly. The alerting and reporting system 104 may initiate a responsive action that includes, for example, shifting the execution of the operations 224 and 230 to different computing hardware such as, for example, a different server, a different cloud hyper scaler, and/or the like.

Consider another example in which employee users are repeatedly initiating the operation 212 to create a purchase requisition with a cost center, but not completing the operation 212 and then subsequently executing the operations 214 and 216 to create the purchase requisition with the catalog. In this example, an entropy of the operation 212 may increase. Also, the centrality of the operation 212 may also increase. The anomaly detection system 112 may detect an anomaly and identify the operation 212 as being correlated to the anomaly. The responsive action may include sending a message to the administrative user 126 identifying the anomaly. The administrative user 126 may respond, for example, by modifying the design of the process flow and/or the user interface 134, 136 to clarify to employee users which operations should be used.

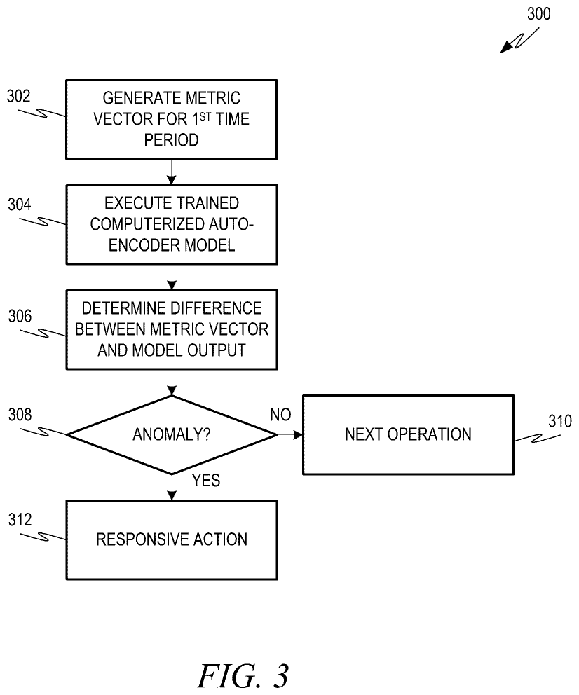

FIG. 3 is a flowchart showing one example of a process flow 300 that may be executed in the environment 100 of FIG. 1 to manage a repeating computerized process. At block 302, the process monitoring system 102 may generate a metric vector for a first time period. The metric vector for the first time period may include components that are or are based on metrics describing operations of a repeating computerized process during the first time period. For example, components of the metric vector may include centralities of the respective operations, entropies of the respective operations, entropies of other metrics describing the respective operations, and/or the like.

At block 304, the process monitoring system 102 may execute the trained computerized autoencoder model 114 using the metric vector as input. The result may be a modeled metric vector. At block 306, the process monitoring system may determine a difference between the metric vector generated at block 302 and the modeled metric vector generated by the trained computerized autoencoder model 114. Based on the difference between the metric vector and the modeled metric vector, the process monitoring system 102 may determine, at block 308, whether the executions of the repeating computerized model during a time period described by the metric vector are anomalous. If no anomaly is detected, the process monitoring system 102 may execute its next operation at 310. This may include, for example, gathering additional data about the execution of the repeating computerized process, generating additional metric vectors describing subsequent time periods, and detecting any anomalies in the repeating computerized process during the subsequent time periods.

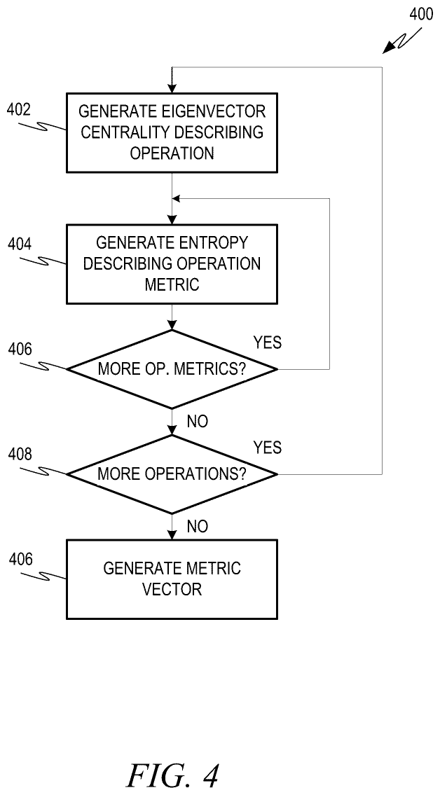

If an anomaly is detected for the considered time period, the process monitoring system 102 may execute a responsive action at block 312. As described herein, the responsive action may include, for example, sending an alert message to an administrative user, modifying the execution of the repeating computerized process 140, and/or the like. In some examples, the particular responsive action may be selected by the process monitoring system 102 based on the nature, type, and/or severity of the anomaly. For example, for anomalies having a high severity, indicated by a large difference between the metric vector generated at block 302 and the modeled metric vector generated by the trained computerized autoencoder model 114, the process monitoring system 102 may execute an automatic modification to the repeating computerized process 140 and send an alert message to an administrative user. Less severe anomalies may result in an alert message only. FIG. 4 is a flowchart showing one example of a process flow 400 that may be executed in the environment 100 of FIG. 1 to generate a metric vector describing the operation of a repeating computerized process over a time period. For example, the process flow 400 shows one example way of executing the block 302 of the process flow 300.

At block 402, the process monitoring system 102 may generate an eigenvector centrality describing a first operation of the repeating computerized process. At block 404, the process monitoring system 102 may generate an entropy describing the first operation and/or a metric of the first operation. At block 406, the process monitoring system 102 may determine if there are any additional metrics describing the operation. If there are additional metrics describing the operation, the process monitoring system 102 may return to block 404 and generate an entropy value describing the next metric of the operation. When entropies have been determined for all metrics of an operation, the process monitoring system 102 may, at block 408, determine if there are additional operations of the repeating computerized process that have not yet been considered.

If there are more operations that have not yet been considered, the process monitoring system 102 may consider the next operation at block 402. If there are no more operations to be considered, the process monitoring system 102 may generate a metric vector for the repeating computerized process at block 406. This may include, for example, concatenating the eigenvector centralities determined at block 402 and the entropies determined at block 404 as components of the metric vector.

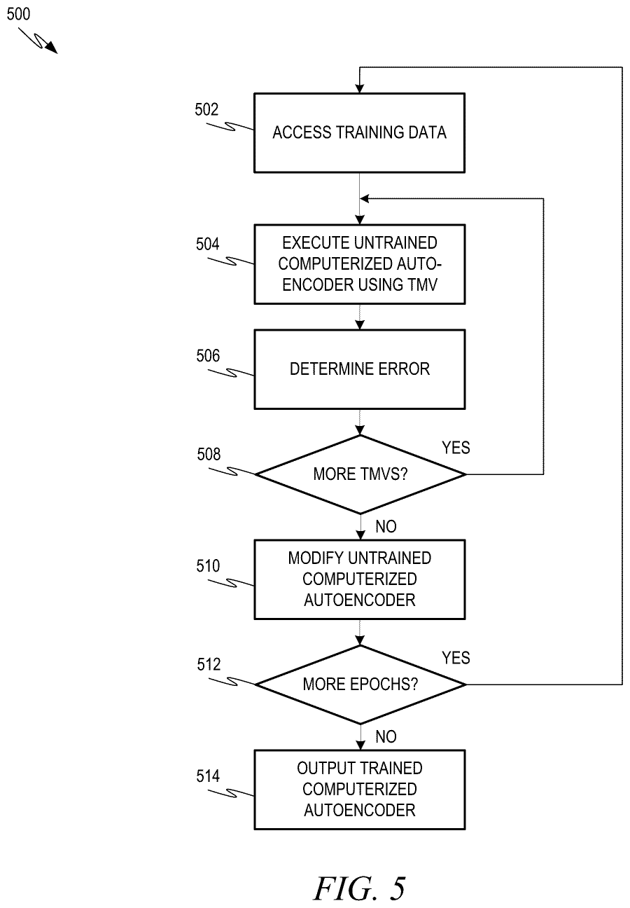

FIG. 5 is a flowchart showing one example of a process flow 500 that may be executed in the environment 100 of FIG. 1 to train the computerized autoencoder model 114. The process flow 500 shows one example way of training a trained computerized auto-encoder model used at operation 304 of the process 300 described herein. The process flow 500 is described herein as being executed by the process monitoring system 102. It will be appreciated, however, that the process flow 500 may be executed by the process monitoring system 102 and/or by another suitable computing system. At block 502, the process monitoring system 102 may access training data. The training data comprises data describing executions of the considered repeating computerized process that are considered to be correct or non-anomalous. In some examples, an administrative user may review data describing various executions of the repeating computerized process and select executions that are correct or non-anomalous. Data describing the correct or nonanomalous executions of the repeating computerized process may be used to generate metric vectors describing the correct or nonanomalous execution of the repeating computerized process over different time periods. In some examples, the training data accessed at block 502 may be raw training data that is to be converted to metric vectors and/or pre-converted training data that already includes metric vectors. Training data accessed at block 502 and/or generated from data accessed at block 502 may include a set of training metric vectors.

At block 504, the process monitoring system 102 may execute an untrained or incompletely trained instance of the computerized autoencoder model using a metric vector from the training data accessed at block 502. This may generate a modeled metric vector, as described herein. At block 506, the process monitoring system 102 may determine an error between the input metric vector and the modeled metric vector. At block 508, the process monitoring system 102 may determine if there are more training metric vectors to be considered. If there are more training metric vectors to be considered, the process monitoring system 102 may re-execute the computerized autoencoder model at block 504 for using the next training metric vector.

If there are no more training metric vectors yet to be used at block 506, the process monitoring system 102 may, at block 510, modify the computerized autoencoder model based on the error determined at block 506. At block 512, the process monitoring system 102 may determine if any additional training epochs are to be executed. If additional training epochs are to be executed, the process monitoring system 102 may re-execute the now-modified computerized autoencoder model using the training metric vectors. When all desired training epochs are completed, the process monitoring system 102 may, at block 514, output the trained computerized autoencoder model 114.

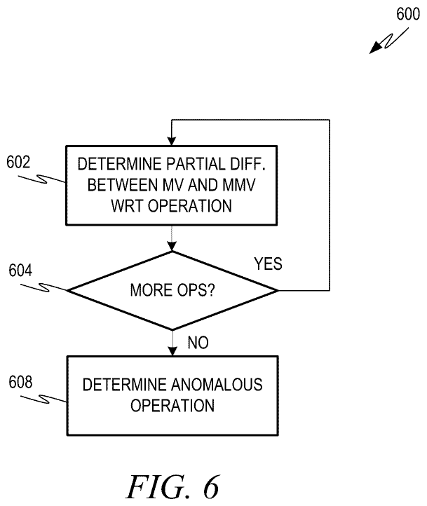

FIG. 6 is a flowchart showing one example of a process flow 600 that may be executed in the environment 100 of FIG. 1 to determine an operation or operations that are correlated to a detected anomaly at a repeating computerized process. The process flow 600 may be executed, for example, when anomalous execution of the repeating computerized process has been detected over a considered time period. For example, the process flow 600 may begin with a metric vector describing the considered time period and a modeled metric vector generated using the trained computerized autoencoder model 114.

At block 602, the process monitoring system 102 may determine a partial difference between the metric vector and the modeled metric vector with respect to a first operation of the repeating computerized process. The partial difference may represent a difference between the respective dimensions of the metric vector and the modeled metric vector corresponding to the considered operation. In some examples, the partial difference may be determined using a partial derivative, as described herein.

At block 604, the process monitoring system 102 may determine if there are additional operations of the repeating computerized process that have yet to be considered. If there are more operations, the process monitoring system 102 may return to block 602 and determine a partial difference between the metric vector and the modeled metric vector with respect to a next operation. When partial differences have been determined with respect to all or a desired portion of the operations of the repeating computerized process, the process monitoring system 102 can determine one or more anomalous operations at block 608. Anomalous operations may be operations having a partial difference that exceeds a threshold.

In some examples, the process flow 600 may be performed in conjunction with the process flow 300. For example, the process flow 600 may be executed if an anomaly is detected at operation 308 in order to identify and operation or operations that are correlated to the detected anomaly. The process monitoring system 102 may be configured to select a responsive action at operation 312 to address the operation or operations that are correlated to the detected anomaly.

In view of the disclosure above, various examples are set forth below. It should be noted that one or more features of an example, taken in isolation or combination, should be considered within the disclosure of this application.

### Examples

Example 1 is a system for managing a repeating computerized process, the repeating computerized process comprising a first operation and a second operation, the system comprising: at least one processor programmed to perform operations comprising: generating a first metric vector describing execution of the repeating computerized process during a first time period, the first metric vector being based at least in part on a first metric value describing execution of the first operation during the first time period and a second metric value describing execution of the second operation during the first time period; executing a trained computerized autoencoder model using the first metric vector to generate a first modeled metric vector; determining a difference between the first metric vector and the first modeled metric vector; based on the difference, detecting an anomaly in the execution of the repeating computerized process during the first time period; and responsive to detecting the anomaly in the execution of the repeating computerized process during the first time period, executing a responsive action.

In Example 2, the subject matter of Example 1 optionally includes the first metric value describing an eigenvector centrality of the first operation during the first time period.

In Example 3, the subject matter of any one or more of Examples 1-2 optionally includes the first metric value describing an entropy of the first operation during the first time period.

In Example 4, the subject matter of any one or more of Examples 1-3 optionally includes the first metric vector also being based at least in part on a second metric value describing execution of the first operation during the first time period.

In Example 5, the subject matter of any one or more of Examples 1-4 optionally includes the trained computerized autoencoder model comprising a Long Short Term Memory (LSTM) autoencoder.

In Example 6, the subject matter of any one or more of Examples 1-5 optionally includes the executing of the trained computerized autoencoder model also using a second metric vector describing execution of the repeating computerized process during a second time period before the first time period.

In Example 7, the subject matter of any one or more of Examples 1-6 optionally includes the operations further comprising: accessing training data, the training data comprising a plurality of training metric vectors describing non-anomalous operation of the repeating computerized process; executing an untrained computerized autoencoder using a first training metric vector of the plurality of training metric vectors to generate a first modeled training metric vector; determining an error based at least in part on a difference between the first training metric vector and the first modeled training metric vector; and generating the trained computerized autoencoder model based at least in part on the error.

In Example 8, the subject matter of any one or more of Examples 1-7 optionally includes the operations further comprising determining that the anomaly is caused at least in part by the first operation.

In Example 9, the subject matter of any one or more of Examples 1-8 optionally includes the operations further comprising: determining a partial difference between the first metric vector and the first modeled metric vector with respect to the first operation; and determining a partial difference between the first metric vector and the first modeled metric vector with respect to the second operation, the determining that the anomaly is caused at least in part by the first operation being based on the partial difference between the first metric vector and the first modeled metric vector with respect to the first operation and the partial difference between the first metric vector and the first modeled metric vector with respect to the second operation.

In Example 10, the subject matter of Example 9 optionally includes the responsive action comprising shifting execution of the first operation from a first computing device to a second computing device.

In Example 11, the subject matter of any one or more of Examples 1-10 optionally includes the responsive action comprising sending an alert message to an administrative user.

In Example 12, the subject matter of any one or more of Examples 1 -11 optionally includes wherein during the first time period, the first operation is executed at a first computing device and the second operation is executed at a second computing device different than the first computing device.

Example 13 is a method of managing a repeating computerized process, the repeating computerized process comprising a first operation and a second operation, the method comprising: generating a first metric vector describing execution of the repeating computerized process during a first time period, the first metric vector being based at least in part on a first metric value describing execution of the first operation during the first time period and a second metric value describing execution of the second operation during the first time period; executing a trained computerized autoencoder model using the first metric vector to generate a first modeled metric vector; determining a difference between the first metric vector and the first modeled metric vector; based on the difference, detecting an anomaly in the execution of the repeating computerized process during the first time period; and responsive to detecting the anomaly in the execution of the repeating computerized process during the first time period, executing a responsive action.

In Example 14, the subject matter of Example 13 optionally includes the first metric value describing an eigenvector centrality of the first operation during the first time period.

In Example 15, the subject matter of any one or more of Examples 13-14 optionally includes the first metric value describing an entropy of the first operation during the first time period.

In Example 16, the subject matter of any one or more of Examples 13-15 optionally includes the first metric vector also being based at least in part on a second metric value describing execution of the first operation during the first time period.

In Example 17, the subject matter of any one or more of Examples 13-16 optionally includes the trained computerized autoencoder model comprising a Long Short Term Memory (LSTM) autoencoder.

In Example 18, the subject matter of any one or more of Examples 13-17 optionally includes the executing of the trained computerized autoencoder model also using a second metric vector describing execution of the repeating computerized process during a second time period before the first time period.

In Example 19, the subject matter of any one or more of Examples 13-18 optionally includes accessing training data, the training data comprising a plurality of training metric vectors describing non-anomalous operation of the repeating computerized process; executing an untrained computerized autoencoder using a first training metric vector of the plurality of training metric vectors to generate a first modeled training metric vector; determining an error based at least in part on a difference between the first training metric vector and the first modeled training metric vector; and generating the trained computerized autoencoder model based at least in part on the error.

Example 20 is a non-transitory machine-readable medium comprising instructions thereon that, when executed by at least one processor, cause the at least one processor to perform operations comprising: generating a first metric vector describing execution of a repeating computerized process during a first time period, the first metric vector being based at least in part on a first metric value describing execution of the first operation during the first time period and a second metric value describing execution of the second operation during the first time period, the repeating computerized process comprising a first operation and a second operation; executing a trained computerized autoencoder model using the first metric vector to generate a first modeled metric vector; determining a difference between the first metric vector and the first modeled metric vector; based on the difference, detecting an anomaly in the execution of the repeating computerized process during the first time period; and responsive to detecting the anomaly in the execution of the repeating computerized process during the first time period, executing a responsive action.

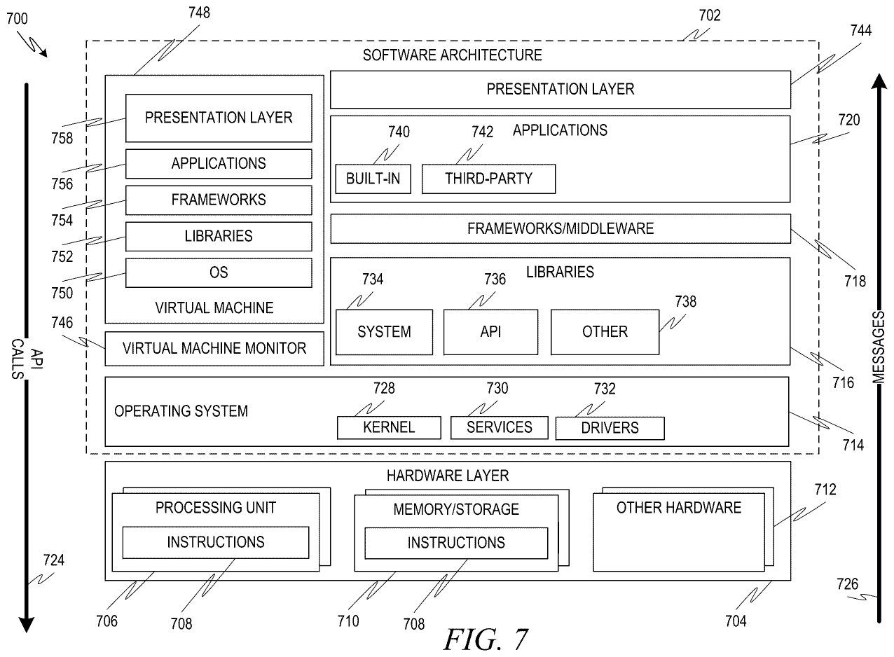

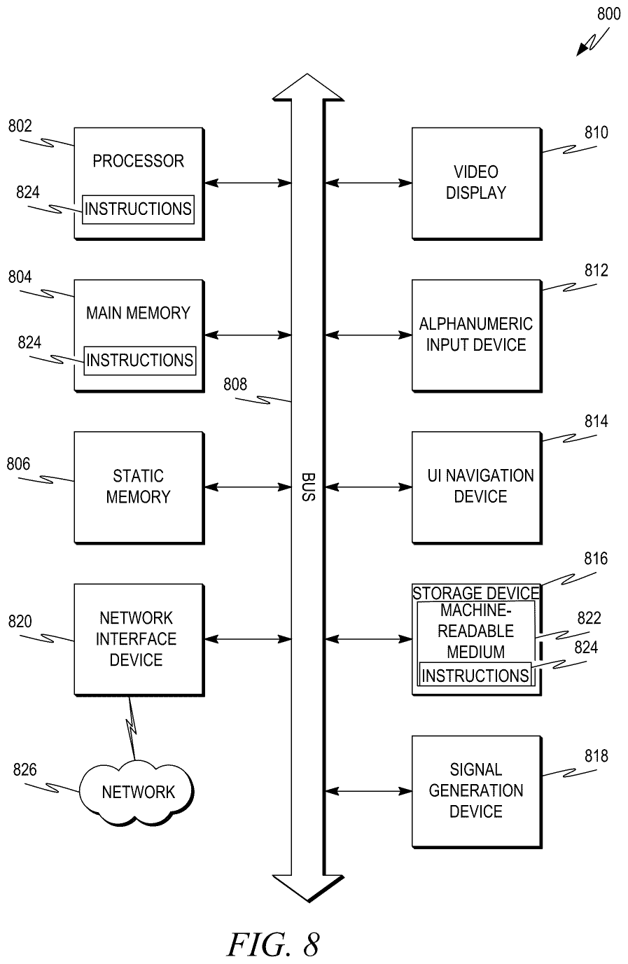

FIG. 7 is a block diagram 700 showing one example of a software architecture 702 for a computing device. The architecture 702 may be used in conjunction with various hardware architectures, for example, as described herein. FIG. 7 is merely a non-limiting example of a software architecture, and many other architectures may be implemented to facilitate the functionality described herein. A representative hardware layer 704 is illustrated and can represent, for example, any of the above-referenced computing devices. In some examples, the hardware layer 704 may be implemented according to the architecture of the computing system of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712, which represents any other hardware of the hardware layer 704, such as the other hardware illustrated as part of the architecture 702.

In the example architecture of FIG. 7, the software architecture 702 may be conceptualized as a stack of layers where each layer provides particular functionality. For example, the software architecture 702 may include layers such as an operating system 714, libraries 716, middleware layer 718, applications 720, and presentation layer 744. Operationally, the applications 720 and/or other components within the layers may invoke API calls 724 through the software stack and access a response, returned values, and so forth illustrated as messages 726 in response to the API calls 724. The layers illustrated are representative in nature and not all software architectures have all layers. For example, some mobile and/or special-purpose operating systems may not provide a middleware layer 718, while others may provide such a layer. Other software architectures may include additional and/or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the architecture 702 to pause its current processing and execute an interrupt service routine (ISR) when an interrupt is accessed.

The drivers 732 may be responsible for controlling and/or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system 734 libraries (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The middleware layer 718 (also sometimes referred to as frameworks) may provide a higher-level common infrastructure that may be utilized by the applications 720 and/or other software components/modules. For example, the middleware layer 718 may provide various graphic user interface (GUI) functions, high-level resource management, high-level location services, and so forth. The middleware layer 718 may provide a broad spectrum of other APIs that may be utilized by the applications 720 and/or other software components/modules, some of which may be specific to a particular operating system and/or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built-in applications 740 as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built-in operating system functions (e.g., kernel 728, services 730 and/or drivers 732), libraries (e.g., system 734, API libraries 736, and other libraries 738), and middleware layer 718 to create user interfaces to interact with users of the system. Alternatively, or additionally, in some systems interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (i.e., operating system 714). A software architecture executes within the virtual machine such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computing systems (e.g., a standalone, client, or server computing system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, an apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of a machine in the example form of a computing system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing system 800 includes a processor 802 (e.g., a central processing unit (CPU), a graphics processing unit (GPU), or both), a main memory 804, and a static memory 806, which communicate with each other via a bus 808. The computing system 800 may further include a video display unit 810 (e.g., a liquid crystal display (LCD) or a cathode ray tube (CRT)). The computing system 800 also includes an alphanumeric input device 812 (e.g., a keyboard or a touch-sensitive display screen), a user interface navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computing system 800, with the main memory 804 and the processor 802 also constituting machine-readable media 822.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system for managing a repeating computerized process, the repeating computerized process comprising a first operation and a second operation, the system comprising:
at least one processor programmed to perform operations comprising:
generating a first metric vector describing execution of the repeating computerized process during a first time period, the first metric vector being based at least in part on a first metric value describing execution of the first operation during the first time period and a second metric value describing execution of the second operation during the first time period;
executing a trained computerized autoencoder model using the first metric vector to generate a first modeled metric vector;
determining a difference between the first metric vector and the first modeled metric vector;
based on the difference, detecting an anomaly in the execution of the repeating computerized process during the first time period; and
responsive to detecting the anomaly in the execution of the repeating computerized process during the first time period, executing a responsive action.

2. The system of claim 1, the first metric value describing an eigenvector centrality of the first operation during the first time period.

3. The system of claim 1, the first metric value describing an entropy of the first operation during the first time period.

4. The system of claim 1, the first metric vector also being based at least in part on a second metric value describing execution of the first operation during the first time period.

5. The system of claim 1, the trained computerized autoencoder model comprising a Long Short Term Memory (LSTM) autoencoder.

6. The system of claim 1, the executing of the trained computerized autoencoder model also using a second metric vector describing execution of the repeating computerized process during a second time period before the first time period.

7. The system of claim 1, the operations further comprising:
accessing training data, the training data comprising a plurality of training metric vectors describing non-anomalous operation of the repeating computerized process;
executing an untrained computerized autoencoder using a first training metric vector of the plurality of training metric vectors to generate a first modeled training metric vector;
determining an error based at least in part on a difference between the first training metric vector and the first modeled training metric vector; and
generating the trained computerized autoencoder model based at least in part on the error.

8. The system of claim 1, the operations further comprising determining that the anomaly is caused at least in part by the first operation.

9. The system of claim 1, the operations further comprising:
determining a partial difference between the first metric vector and the first modeled metric vector with respect to the first operation; and
determining a partial difference between the first metric vector and the first modeled metric vector with respect to the second operation, the determining that the anomaly is caused at least in part by the first operation being based on the partial difference between the first metric vector and the first modeled metric vector with respect to the first operation and the partial difference between the first metric vector and the first modeled metric vector with respect to the second operation.

10. The system of claim 9, the responsive action comprising shifting execution of the first operation from a first computing device to a second computing device.

11. The system of claim 1, the responsive action comprising sending an alert message to an administrative user.

12. The system of claim 1, wherein during the first time period, the first operation is executed at a first computing device and the second operation is executed at a second computing device different than the first computing device.

13. A method of managing a repeating computerized process, the repeating computerized process comprising a first operation and a second operation, the method comprising:
generating a first metric vector describing execution of the repeating computerized process during a first time period, the first metric vector being based at least in part on a first metric value describing execution of the first operation during the first time period and a second metric value describing execution of the second operation during the first time period;
executing a trained computerized autoencoder model using the first metric vector to generate a first modeled metric vector;
determining a difference between the first metric vector and the first modeled metric vector;
based on the difference, detecting an anomaly in the execution of the repeating computerized process during the first time period; and
responsive to detecting the anomaly in the execution of the repeating computerized process during the first time period, executing a responsive action.

14. The method of claim 13, the first metric value describing an eigenvector centrality of the first operation during the first time period.

15. The method of claim 13, the first metric value describing an entropy of the first operation during the first time period.

16. The method of claim 13, the first metric vector also being based at least in part on a second metric value describing execution of the first operation during the first time period.

17. The method of claim 13, the trained computerized autoencoder model comprising a Long Short Term Memory (LSTM) autoencoder.

18. The method of claim 13, the executing of the trained computerized autoencoder model also using a second metric vector describing execution of the repeating computerized process during a second time period before the first time period.

19. The method of claim 13, further comprising:
accessing training data, the training data comprising a plurality of training metric vectors describing non-anomalous operation of the repeating computerized process;
executing an untrained computerized autoencoder using a first training metric vector of the plurality of training metric vectors to generate a first modeled training metric vector;
determining an error based at least in part on a difference between the first training metric vector and the first modeled training metric vector; and
generating the trained computerized autoencoder model based at least in part on the error.

20. A non-transitory machine-readable medium comprising instructions thereon that, when executed by at least one processor, cause the at least one processor to perform operations comprising:
generating a first metric vector describing execution of a repeating computerized process during a first time period, the first metric vector being based at least in part on a first metric value describing execution of the first operation during the first time period and a second metric value describing execution of the second operation during the first time period, the repeating computerized process comprising a first operation and a second operation;
executing a trained computerized autoencoder model using the first metric vector to generate a first modeled metric vector;
determining a difference between the first metric vector and the first modeled metric vector;
based on the difference, detecting an anomaly in the execution of the repeating computerized process during the first time period; and
responsive to detecting the anomaly in the execution of the repeating computerized process during the first time period, executing a responsive action.
